(19) United States
(12) Patent Application Publication
(10) Pub. No.: US 2026/0141579 A1
(43) Pub. Date: May 21, 2026

(54) IMAGE GENERATION

(71) Applicants: Beijing Zitiao Network Technology Co., Ltd., Beijing (CN); Lemon Inc., Grand Cayman (KY)

(72) Inventors: Xiaochen ZHAO, Beijing (CN); Hongyi XU, Los Angeles, CA (US); Guoxian SONG, Los Angeles, CA (US); You XIE, Los Angeles, CA (US); Chenxu ZHANG, Los Angeles, CA (US); Xiu LI, Beijing (CN); Linjie LUO, Los Angeles, CA (US); Jinli SUO, Beijing (CN); Yebin LIU, Beijing (CN)

(21) Appl. No.: 19/397,697

(22) Filed: Nov. 21, 2025

(30) Foreign Application Priority Data
Nov. 21, 2024 (CN) 202411679321.9

(51) Int. Cl. G06T 11/00; G06N 3/0455; G06T 13/80

(52) U.S. Cl. CPC G06T 11/00; G06N 3/0455; G06T 13/80

(57) ABSTRACT

According to an embodiment of the disclosure, a method, apparatus, device and storage medium for generating an image are provided. The method includes: generating, by a motion encoder, a motion feature of a driving image; determining a transformation feature of a first object in the driving image relative to a second object in a reference image, the transformation feature indicating a position change and/or a size change; updating the motion feature based on the transformation feature; and providing the updated motion feature and an appearance feature of the reference image to a diffusion model to generate a target image, where the target image retains a motion characteristic of the first object in the driving image, and the target image retains an identity characteristic of the second object in the reference image.

### CROSS-REFERENCE TO RELATED APPLICATION

The present application claims priority to Chinese Patent Application No. 202411679321.9, filed Nov. 21, 2024, entitled “METHOD, APPARATUS, DEVICE AND STORAGE MEDIUM FOR GENERATING IMAGE”, the entirety of which is incorporated herein by reference.

### FIELD

Example embodiments of the present disclosure generally relate to the field of computers, and in particular, to image generation.

### BACKGROUND

In a field of artificial intelligence and computer vision, portrait animation technology has always been an active research and development direction. This technique involves, for example, transferring one person's expressions and actions to another person's static portrait, which can be widely used in many industries such as movie production, video games, virtual reality, and digital entertainment. With the explosive growth of digitized content and popularity of social media, the demand for creating realistic and personalized animated portraits is growing.

### SUMMARY

In a first aspect of the present disclosure, a method for generating an image is provided. The method includes: generating, by a motion encoder, a motion feature of a driving image; determining a transformation feature of a first object in the driving image relative to a second object in a reference image, the transformation feature indicating a position change and/or a size change; updating the motion feature based on the transformation feature; and providing the updated motion feature and an appearance feature of the reference image to a diffusion model to generate a target image, wherein the target image retains a motion characteristic of the first object in the driving image, and the target image retains an identity characteristic of the second object in the reference image.

In a second aspect of the present disclosure, an apparatus for generating an image is provided. The apparatus includes: an image encoding module configured to generate, by a motion encoder, a motion feature of a driving image; a feature determining module configured to determine a transformation feature of a first object in the driving image relative to a second object in a reference image, the transformation feature indicating a position change and/or a size change; a feature updating module configured to update the motion feature based on the transformation feature; and an image generation module configured to provide the updated motion feature and an appearance feature of the reference image to a diffusion model to generate a target image, wherein the target image retains a motion characteristic of the first object in the driving image, and the target image retains an identity characteristic of the second object in the reference image.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program thereon, and the computer program is executable by a processor to implement the method of the first aspect.

It should be understood that the content described in this summary section is not intended to limit key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates an example image generation system according to some embodiments of the present disclosure;

FIG. 2 illustrates a flowchart of an example process for generating an image according to some embodiments of the present disclosure;

FIG. 3 illustrates an example training architecture according to some embodiments of the present disclosure;

FIG. 4 illustrates a block diagram of an apparatus for generating an image according to some embodiments of the present disclosure; and

FIG. 5 illustrates a block diagram of an electronic device capable of implementing various embodiments of the present disclosure.

### DETAILED DESCRIPTION

It can be understood that, before technical solutions disclosed in the embodiments of the present disclosure are used, types, usage scopes, usage scenarios and the like of personal information related to the present disclosure should be informed to the user and obtain user authorization in an appropriate manner according to relevant laws and regulations.

For example, in response to receiving an active request from a user, prompt information is sent to the user to explicitly prompt the user that the operation requested to perform will need to acquire and use the personal information of the user. Therefore, the user can autonomously select whether to provide personal information to software or hardware such as electronic devices, application programs, servers and storage media which execute the operation of the technical solution of the present disclosure according to the prompt information.

As an optional but non-limiting implementation, in response to receiving the active request of the user, a manner of sending the prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process are merely illustrative, and do not constitute a limitation on implementations of the present disclosure, and other manners which meet related laws and regulations may also be applied to implementations of the present disclosure.

It may be understood that the data involved in the present technical solution (including but not limited to the data itself, acquisition or usage of the data) should follow corresponding laws and regulations and requirements of relevant rules.

The term “in response to” used herein represents a state in which a corresponding event occurs or a condition is satisfied. It will be understood that the timing of execution of a subsequent action performed in response to the event or condition is not necessarily strongly correlated with the time at which the event occurs or the condition holds. For example, in some cases, the subsequent action may be performed immediately when the event occurs or the condition holds; while in other cases, the subsequent action may be performed a period of time after the event occurs or the condition holds.

Embodiments of the present disclosure will be described in more detail below with reference to the accompanying drawings. Although some embodiments of the present disclosure are shown in the accompanying drawings, it should be understood that the present disclosure may be implemented in various forms, and should not be interpreted as limited to embodiments set forth herein, on the contrary, these embodiments are provided for a more thorough and complete understanding of the present disclosure. It should be understood that the drawings and embodiments of the present disclosure are merely for example purposes and are not intended to limit the scope of the present disclosure.

It should be noted that the title of any section/subsection provided herein is not limiting. Various embodiments are described throughout and any type of embodiment may be included in any section/subsection. Furthermore, the embodiments described in any section/subsection may be combined in any manner with any other embodiments described in the same section/subsection and/or different section/subsection.

In the description of the embodiments of the present disclosure, the term “comprising” and the like should be understood as openness, i.e., “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first” “second” and the like may refer to different or identical objects. Other explicit and implicit definitions may also be included below.

Portrait animation typically relies on complex motion capture devices or deep learning models, these methods have made some progress in capturing and reproducing human facial details, but they also have limitations. For example, traditional motion capture techniques are costly and may not be accurate enough to handle extreme expressions or non-cooperative objects. In addition, a deep learning based solution may generate a more realistic animation driven by data. However, such a solution often requires a large amount of annotation data, and may encounter a problem of identity information leakage when transferring expression between different identities.

To this end, the embodiments of the present disclosure provide a solution for generating an image. According to various embodiments of the present disclosure, a motion feature of a driving image may be generated by a motion encoder. Further, a transformation feature of a first object in the driving image relative to a second object in a reference image may be determined, the transformation feature indicates a position change and/or a size change, and the motion feature may be updated based on the transformation feature.

In addition, the updated motion feature and an appearance feature of the reference image may be provided to a diffusion model to generate a target image, where the target image retains a motion characteristic of the first object in the driving image, and the target image retains an identity characteristic of the second object in the reference image.

Thus, the embodiments of the present disclosure can extract fine motion information from the driving image, and can transfer the motion information to the reference image, and maintain the identity characteristic of the reference image. In this way, the embodiments of the present disclosure can effectively decouple the identity information and the motion information, avoid leakage of the identity information, and improve accuracy and naturalness of motion transformation.

Example embodiments of the present disclosure are described below with reference to the accompanying drawings.

### Example System

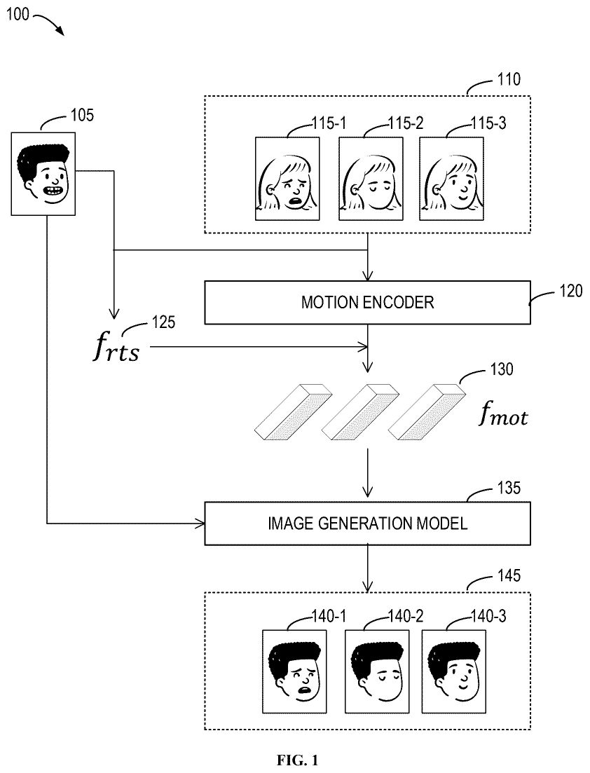

FIG. 1 illustrates an example structure of an example image generation system 100 according to some embodiments of the present disclosure. As shown in FIG. 1, the image generation system 100 may include a motion encoder 120 and an image generation model 135.

As shown, the motion encoder 120 may obtain driving images, e.g., driving image 115-1, driving image 115-2, and driving image 115-3 (individually or collectively referred to as driving image 115). In some embodiments, such a driving image 115 may be one or more video frames from a driving video 110.

As will be described in detail below, the motion encoder 120 may obtain a motion feature 130 corresponding to respective driving images 115 by encoding the respective driving images 115.

In addition, the image generation model 135 may obtain the motion feature 130 and an appearance feature of a reference image 105 to generate a target image corresponding to the motion feature 130. As shown, the image generation model 135 may generate a corresponding target image 140-1 based on the motion feature of the driving image 115-1, the image generation model 135 may generate a corresponding target image 140-2 based on the motion feature of the driving image 115-2, and the image generation model 135 may generate a corresponding target image 140-3 based on the motion feature of the driving image 115-3.

The target image 140-1, the target image 140-2, and the target image 140-3 may be individually or collectively referred to as a target image 140. Such a target image 140 may constitute one or more video frames in a target video 145. Thus, the motion information of the driving video 110 and the appearance information of the static reference image 105 may be used to generate the target video 145 to retain the motion characteristic of the driving video 110 and retain the identity characteristic in the reference image 105.

As shown in FIG. 1, the generated target image 140 may retain a motion characteristic of a first object in the driving image 115. Taking the first object including a facial object as an example, the target image 140 may retain a facial motion (for example, opening the mouth, frowning, and the like) of the facial object.

Additionally, as shown in FIG. 1, the generated target image 140 may also retain the identity characteristic of the second object in the reference image 105. It should be understood that identity maintaining refers to: in the field of image generation, in a process of processing an image, converting an image or generating a new image, the ability to maintain an identifiable characteristic of the object in the image and maintain identity information of an individual unchanged. Taking the second object including a facial object as an example, the target image 140 may retain the identity characteristic (for example, an appearance characteristic) of the facial object.

The specific generation process of the target image 140 will be described in detail below.

### Example Processes

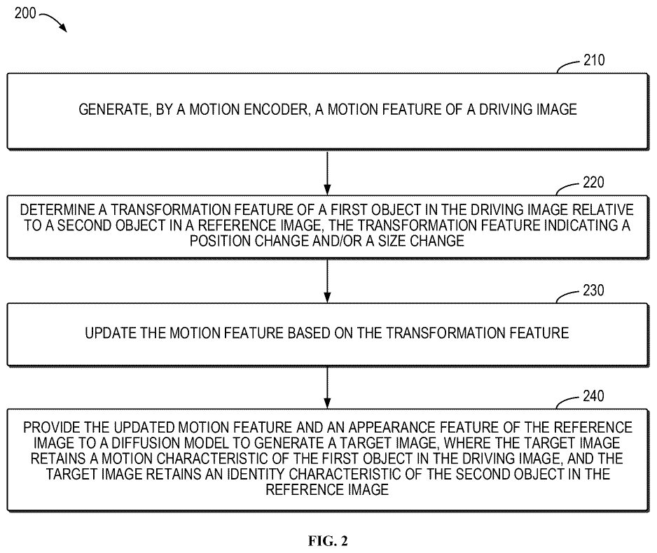

FIG. 2 illustrates a flowchart of an example process 200 of a training image generation model according to some embodiments of the present disclosure. The process 200 may be implemented at an appropriate electronic device which deploys the image generation system 100 as shown in FIG. 1. The process 200 is described below with reference to FIG. 1.

As shown in FIG. 2, at block 210, the electronic device generates a motion feature of a driving image by a motion encoder.

In some embodiments, as shown in FIG. 1, the electronic device may encode the driving image 115 by the trained motion encoder 120 to generate a corresponding motion encoded representation.

At block 220, the electronic device determines a transformation feature of a first object in the driving image relative to a second object in a reference image, the transformation feature indicating a position change and/or a size change.

As shown in FIG. 1, the electronic device 110 may determine a first region in the driving image 115 that corresponds to the first object. As an example, the first object may include a facial object, and the first region may include an image region corresponding to the facial object in the driving image 115.

Additionally, the electronic device 110 may determine a second region in the reference image 105 that corresponds to the second object. Similarly, the second object may include a facial object, and the second region may include an image region corresponding to the facial object in the reference image 105.

Further, the electronic device 110 may determine the transformation feature based on the first region and the second region. In some embodiments, the transformation feature fᵣₗₛ a may be represented as a triplet shown as Formula (1):

$${f}_{rts} = ( Δ x / {s}_{r} , Δ y / {s}_{r} , {s}_{d} / {s}_{r} ) \qquad ( 1 )$$

where (Δx, Δy) respectively represents a distance between a center point of the first region and a center point of the second region on the x axis and the y axis; s_{d} and sᵣ respectively represents a size of the first region in the driving image 115 and a size of the second region in the reference image 105.

At block 230, the electronic device updates the motion feature based on the transformation feature.

In some embodiments, the electronic device may project the transformation feature fᵣₜₛ to a dimension corresponding to the motion feature output by the motion encoding unit 120, and may further update the motion feature by fusing the projected transformation feature and the motion feature. As an example, the electronic device may implement fusion of the transformation features and the motion features by a fully connected layer.

As shown, the electronic device 110 may obtain the updated motion feature 130, e.g., fₘₒₜ. In some embodiments, the motion encoded representation and the motion feature fₘₒₜ output by the motion encoding unit 120 may both be a one-dimensional vector. By compressing the motion information into a one-dimensional vector, the embodiments of the present disclosure can avoid signals including any two-dimensional image structure and reduce leakage of the identity information.

At block 240, the electronic device provides the updated motion feature and the appearance feature of the reference image to a diffusion model to generate a target image, where the target image retains a motion characteristic of the first object in the driving image, and the target image retains an identity characteristic of the second object in the reference image.

In some embodiments, the reference image may be encoded by a spatial encoder to obtain the appearance feature of the reference image. Further, the appearance feature of the reference image 105, the motion feature 130 of the driving image 115 may be provided to a diffusion model to generate the target image 140 as shown in FIG. 1. Specifically, the motion feature 130 of the driving image 115 may be injected into a diffusion model, for example, through a cross-attention mechanism to generate the target image 140.

By using the cross-attention mechanism, the embodiments of the present disclosure can more accurately control injection of the motion information and reduce leakage of the identity information.

Based on the process described above, the embodiments of the present disclosure can extract fine motion information from the driving image, and can transfer the motion information to the reference image and maintain the identity characteristic of the reference image. In this way, the embodiments of the present disclosure can effectively decouple the identity information and the motion information, avoid leakage of the identity information, and improve accuracy and naturalness of motion transformation.

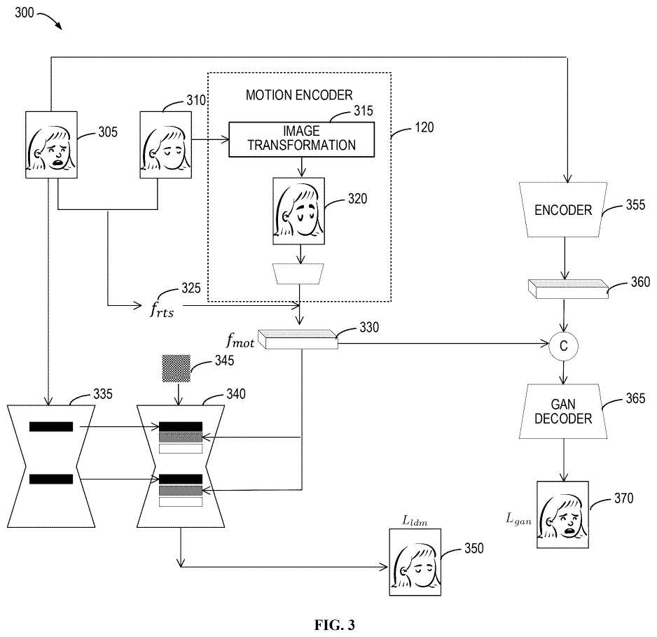

A training process 300 of the image generation system 100 will be further described below with reference to FIG. 3. The training process 300 may be performed, for example, by an appropriate training device.

As shown in FIG. 3, the training device may obtain a sample image pair, and the sample image pair may include a first image 305 and a second image 310. In some embodiments, the sample image pair may include two video frames in a video that are associated with the same reference object. During training, the first image 305 may be understood as training reference image and the second image 310 may be understood as training driving image.

Further, as shown in FIG. 3, during a process of processing the second image 310 by the motion encoder 120, the training device may further apply a predetermined image transformation process on the second image 310 by the image transformation unit 315 to obtain a third image 320.

In some embodiments, the image transformation process applied by the image transformation unit 315 may include color transformation and/or spatial transformation.

As an example, the image transformation unit 315 may apply a color transformation on the second image 310 to change the color of the second image 310. As another example, the image transformation unit 315 may also apply a scaling transformation to the second image 310 to stretch or downscale the second image 310.

In some embodiments, the image transformation unit 315 may also apply a pixel-by-pixel affine transformation on a reference object in the second image 310. Taking the reference object including the facial object as an example, the image transformation unit 315 may apply an affine transformation, such as scaling and rotation, to the facial object in the second image 310. These affine transformations may change the appearance of the facial object while maintaining a relative positional relationship between facial features.

In some embodiments, the image transformation unit 315 may also crop a region in the second image that corresponds to the reference object. Taking the reference object including the facial object as an example, the image transformation unit 315 may crop the second image 310 based on a center point of the facial object, so that the obtained image focuses more on the facial object.

Further, the training device may encode the third image by the motion encoder 120 to determine the training motion feature 330.

Specifically, the training device may obtain an intermediate motion feature generated by the motion encoder 120 through encoding the third image 320. Further, similar to the above process of determining the transformation feature 125, the training device may also determine a training transformation feature 325 associated with a reference object in the sample image pair, the transformation feature indicates a position change and/or a size change.

Further, the training device may fuse the intermediate motion feature and the training transformation feature 325 to determine the training motion feature 330.

As shown in FIG. 3, the training device may further encode the first image 305 by the spatial encoder 335 to obtain a training appearance feature of the first image. Further, the training device may provide the training appearance feature of the first image 305, the training motion feature 330 of the second image 320, and noise 345 to the diffusion model 340, thereby generating a fourth image 350.

In some embodiments, in the training process, the training device may further mask the appearance encoded representation of the first image 305. Specifically, the training device may obtain the appearance encoded representation output by the spatial encoder 335. Further, the training device may mask the appearance encoded representation. For example, the training device may determine the training appearance feature by setting a part of content of the appearance encoded representation to a predetermined value. As an example, the training device may apply a predetermined proportion of uniform random masking.

In this way, the embodiments of the present disclosure can simulate diversity of the identity in the training data by random masking, thereby enhancing the generalization ability of the model to different objects. Therefore, the embodiments of the present disclosure can enable the model to generate accurate actions on objects that are never been seen.

Further, the training device may determine a first training loss based on a first difference between the fourth image 350 and the second image 310. The first training loss may be, for example, a training loss related to the diffusion model 340, which may be represented as L_{ldm}. It should be understood that any suitable loss expression known and available by the diffusion model may be used, and the specific definition of diffusion loss will not be described in detail in the present disclosure.

Accordingly, the training device may train the image generation system 100 based at least on the first training loss L_{ldm} and adjust parameters of the motion encoder 120.

Additionally, in order to avoid the motion feature 330 expressing the identity information of the second image 310, the embodiments of the present disclosure may also consider a second training loss. Specifically, as shown in FIG. 3, the training device may encode the first image by a reference encoder 355 to generate a training appearance feature 350. The reference encoder 355, for example, may include any suitable spatial encoder.

Further, the training device may generate an intermediate feature based on the training appearance feature 360 and the training motion feature 330. For example, the training device may concatenate the training appearance feature 360 and the training motion feature 330 to acquire the intermediate feature.

Further, the training device may decode the intermediate feature by a reference decoder 370 to generate a fifth image 370. In some embodiments, the reference decoder 370 may include, for example, a decoding unit of a generative adversarial network (GAN).

Correspondingly, the training device may determine the second training loss based on a second difference between the fifth image 370 and the first image 305. As an example, the second training loss may include a training loss associated with the generative adversarial network (GAN), which may be represented as L_{gan}. It should be understood that any suitable loss expression known and available by the generative adversarial network may be used, and the specific definition of adversarial loss will not be described in detail in the present disclosure.

Thus, the training device may determine a final training loss based on the first training loss L_{ldm} and the second training loss L_{gan}, thereby training the image generation system 100.

Thus, the embodiments of the present disclosure provide a double-headed latent supervision strategy that enhances the ability of the model to capture detail and local features by incorporating image-level loss of the GAN. In particular, such supervision information helps guide the motion encoder to more accurately learn motion features while avoiding identity leakage issues during generation. In addition, due to the introduction of the GAN loss, the embodiments of the present disclosure can generate a higher quality and more realistic animation frame, and significantly improves the naturalness and accuracy of the actions.

### Example Apparatus and Device

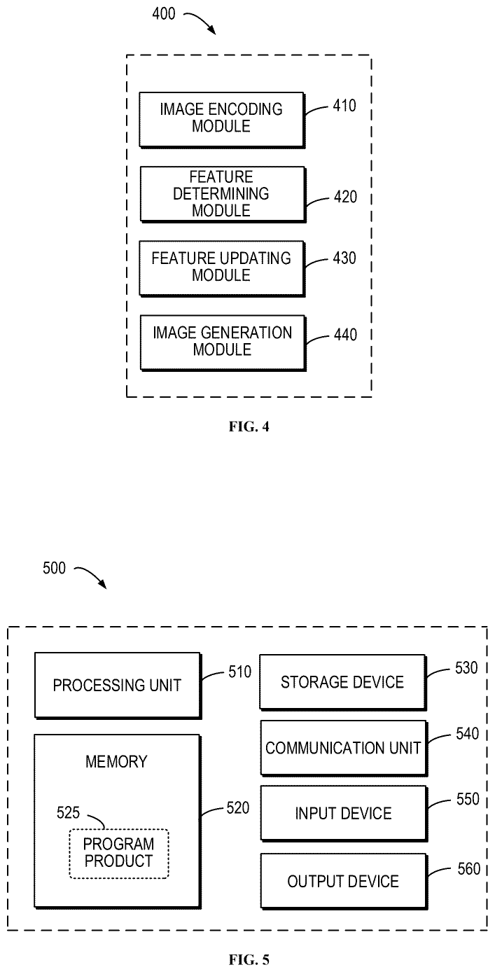

The embodiments of the present disclosure also provide a corresponding apparatus for implementing the above method or process. FIG. 4 illustrates a schematic structural block diagram of an apparatus 400 for training an image generation model according to some embodiments of the present disclosure. The apparatus 400 may be implemented as an electronic device or included in an electronic device. Various modules/components in the apparatus 400 may be implemented by hardware, software, firmware, or any combination thereof.

As shown in FIG. 4, the apparatus 400 includes: an image encoding module 410 configured to generate, by a motion encoder, a motion feature of a driving image; a feature determining module 420 configured to determine a transformation feature of a first object in the driving image relative to a second object in a reference image, the transformation feature indicating a position change and/or a size change; a feature updating module 430 configured to update the motion feature based on the transformation feature; and an image generation module 440 configured to provide the updated motion feature and an appearance feature of the reference image to a diffusion model to generate a target image, where the target image retains a motion characteristic of the first object in the driving image, and the target image retains an identity characteristic of the second object in the reference image.

In some embodiments, the updated motion feature is injected into the diffusion model through a cross-attention mechanism.

In some embodiments, the driving image includes a first set of video frames in a driving video, and the apparatus 400 further includes a video obtaining module configured to obtain a second set of video frames generated based on the first set of video frames, to generate a target video.

In some embodiments, the first object includes a facial object and the motion characteristic indicates at least a facial action of the facial object.

In some embodiments, the feature determination module 420 is further configured to: determine a first region in the driving image that corresponds to the first object; determine a second region in the reference image that corresponds to the second object; and determine the transformation feature based on the first region and the second region.

In some embodiments, the feature updating module 430 is further configured to: project the transformation feature to a dimension corresponding to the motion feature; and update the motion feature by fusing the projected transformation feature and the motion feature.

In some embodiments, the motion encoder is trained by: obtaining a sample image pair including a first image and a second image; applying a predetermined image transformation process to the second image to obtain a third image; encoding the third image by the motion encoder to determine a training motion feature; generating a fourth image by the diffusion model based on a training appearance feature of the first image and the training motion feature; and determining a first training loss based on a first difference between the fourth image and the second image; and training the motion encoder based at least on the first training loss.

In some embodiments, encoding the third image by the motion encoder to determine the training motion feature includes: obtaining an intermediate motion feature generated by the motion encoder through encoding the third image; determining a training transformation feature associated with a reference object in the sample image pair, the transformation feature indicating a position change and/or a size change; and determining the training motion feature by fusing the intermediate motion feature and the training transformation feature.

In some embodiments, the predetermined image transformation process includes at least one of: changing a color of the second image; stretching or downscaling the second image; applying a pixel-by-pixel affine transformation on a reference object in the second image; and cropping a region in the second image that corresponds to the reference object.

In some embodiments, the motion encoder is further trained based on a second training loss, and the second training loss is determined by: encoding the first image by a reference encoder to generate a training appearance feature; generating an intermediate feature based on the training appearance feature and the training motion feature; decoding the intermediate feature by a reference decoder to generate a fifth image; and determining the second training loss based on a second difference between the fifth image and the first image.

In some embodiments, the reference decoder includes a decoding unit in the generative adversarial network, and the second training loss includes a training loss associated with the generative adversarial network.

In some embodiments, generating the fourth image by the diffusion model based on the training appearance feature of the first image and the training motion feature includes: obtaining an appearance encoded representation of the first image; determining the training appearance feature by setting a part of content of the appearance encoded representation to a predetermined value; and providing the training appearance feature and the training motion feature to the diffusion model to generate the fourth image.

In some embodiments, the motion feature is a one-dimensional vector.

Units included in the apparatus 400 may be implemented in various manners, including software, hardware, firmware, or any combination thereof. In some embodiments, one or more units may be implemented using software and/or firmware, such as machine-executable instructions stored on a storage medium. In addition to machine-executable instructions or as an alternative to machine-executable instructions, some or all of the units in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely for example and should not constitute any limitation on the functionality and scope of the embodiments described herein. The electronic device 500 shown in FIG. 5 may be configured to implement the image generation system 100 as described above.

As shown in FIG. 5, the electronic device 500 is in a form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In a multiprocessor system, a plurality of processing units performs computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 530 may be a removable or non-removable medium and may include a machine-readable medium, such as a flash drive, magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with other electronic devices through a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, a computer-readable storage medium having computer executable instructions stored thereon is provided, where the computer executable instructions are executed by a processor to implement the method described above. According to example implementations of the present disclosure, a computer program product is further provided, the computer program product being tangibly stored on a non-transitory computer-readable medium and including computer executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatuses to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagrams.

The computer-readable program instructions may be loaded onto a computer, other programmable data processing apparatuses, or other devices, such that a series of operational steps are performed on a computer, other programmable data processing apparatuses, or other devices to produce a computer-implemented process, thereby enabling the instructions executed on a computer, other programmable data processing apparatuses, or other devices to implement the functions/acts specified in the flowcharts and/or block diagrams block or blocks.

The flowcharts and block diagrams in the drawings show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, and the above descriptions are, for example, not exhaustive, and are not limited to the implementations disclosed. Many modifications and variations without departing from the scope and spirit of the various implementations illustrated will be apparent to those of ordinary skill in the art. Selection of the terms used herein is intended to best explain the principles of the implementations, practical applications, or improvements to techniques in the marketplace, or to enable others of ordinary skill in the art to understand the various implementations disclosed herein.

1. A method for generating an image, comprising:
generating, by a motion encoder, a motion feature of a driving image;
determining a transformation feature of a first object in the driving image relative to a second object in a reference image, the transformation feature indicating at least one of: a position change or a size change;
updating the motion feature based on the transformation feature; and
providing the updated motion feature and an appearance feature of the reference image to a diffusion model to generate a target image, wherein the target image retains a motion characteristic of the first object in the driving image, and the target image retains an identity characteristic of the second object in the reference image.

2. The method of claim 1, wherein the updated motion feature is injected into the diffusion model through a cross-attention mechanism.

3. The method of claim 1, wherein the driving image comprises a first set of video frames in a driving video, and the method further comprises:
obtaining a second set of video frames generated based on the first set of video frames, to generate a target video.

4. The method of claim 1, wherein the first object comprises a facial object and the motion characteristic indicates at least a facial action of the facial object.

5. The method of claim 1, wherein determining the transformation feature of the first object in the driving image relative to the second object in the reference image comprises:
determining a first region in the driving image that corresponds to the first object;
determining a second region in the reference image that corresponds to the second object; and
determining the transformation feature based on the first region and the second region.

6. The method of claim 1, wherein updating the motion feature based on the transformation feature comprises:
projecting the transformation feature to a dimension corresponding to the motion feature; and
updating the motion feature by fusing the projected transformation feature and the motion feature.

7. The method of claim 1, wherein the motion encoder is trained by:
obtaining a sample image pair comprising a first image and a second image;
applying a predetermined image transformation process to the second image to obtain a third image;
encoding the third image by the motion encoder to determine a training motion feature;
generating a fourth image by the diffusion model based on a training appearance feature of the first image and the training motion feature;
determining a first training loss based on a first difference between the fourth image and the second image; and
training the motion encoder based at least on the first training loss.

8. The method of claim 7, wherein encoding the third image by the motion encoder to determine the training motion feature comprises:
obtaining an intermediate motion feature generated by the motion encoder through encoding the third image;
determining a training transformation feature associated with a reference object in the sample image pair, the training transformation feature indicating at least one of: a position change or a size change; and
determining the training motion feature by fusing the intermediate motion feature and the training transformation feature.

9. The method of claim 7, wherein the predetermined image transformation process comprises at least one of:
changing a color of the second image;
stretching or downscaling the second image;
applying a pixel-by-pixel affine transformation on a reference object in the second image; and
cropping a region in the second image that corresponds to the reference object.

10. The method of claim 7, wherein the motion encoder is further trained based on a second training loss, and the second training loss is determined by:
encoding the first image by a reference encoder to generate a training appearance feature;
generating an intermediate feature based on the training appearance feature and the training motion feature;
decoding the intermediate feature by a reference decoder to generate a fifth image; and
determining the second training loss based on a second difference between the fifth image and the first image.

11. The method of claim 10, wherein the reference decoder comprises a decoding unit in a generative adversarial network, and the second training loss comprises a training loss associated with the generative adversarial network.

12. The method of claim 7, wherein generating the fourth image by the diffusion model based on the training appearance feature of the first image and the training motion feature comprises:
obtaining an appearance encoded representation of the first image;
determining the training appearance feature by setting a part of content of the appearance encoded representation to a predetermined value; and
providing the training appearance feature and the training motion feature to the diffusion model to generate the fourth image.

13. The method of claim 1, wherein the motion feature is a one-dimensional vector.

14. An electronic device, comprising:
at least one processor; and
at least one memory coupled to the at least one processor and storing instructions for execution by the at least one processor, wherein the instructions, when executed by the at least one processor, cause the electronic device to perform acts comprising:
generating, by a motion encoder, a motion feature of a driving image;
determining a transformation feature of a first object in the driving image relative to a second object in a reference image, the transformation feature indicating at least one of: a position change, or a size change;
updating the motion feature based on the transformation feature; and
providing the updated motion feature and an appearance feature of the reference image to a diffusion model to generate a target image, wherein the target image retains a motion characteristic of the first object in the driving image, and the target image retains an identity characteristic of the second object in the reference image.

15. The electronic device of claim 14, wherein the updated motion feature is injected into the diffusion model through a cross-attention mechanism.

16. The electronic device of claim 14, wherein the driving image comprises a first set of video frames in a driving video, and the acts further comprise:
obtaining a second set of video frames generated based on the first set of video frames, to generate a target video.

17. The electronic device of claim 14, wherein the first object comprises a facial object and the motion characteristic indicates at least a facial action of the facial object.

18. The electronic device of claim 14, wherein determining the transformation feature of the first object in the driving image relative to the second object in the reference image comprises:
determining a first region in the driving image that corresponds to the first object;
determining a second region in the reference image that corresponds to the second object; and
determining the transformation feature based on the first region and the second region.

19. The electronic device of claim 14, wherein updating the motion feature based on the transformation feature comprises:
projecting the transformation feature to a dimension corresponding to the motion feature; and
updating the motion feature by fusing the projected transformation feature and the motion feature.

20. A non-transitory computer-readable storage medium having a computer program stored thereon, wherein the computer program, when executed by a processor, implements acts comprising:
generating, by a motion encoder, a motion feature of a driving image;
determining a transformation feature of a first object in the driving image relative to a second object in a reference image, the transformation feature indicating at least one of: a position change, or a size change;
updating the motion feature based on the transformation feature; and
providing the updated motion feature and an appearance feature of the reference image to a diffusion model to generate a target image, wherein the target image retains a motion characteristic of the first object in the driving image, and the target image retains an identity characteristic of the second object in the reference image.
